(19) United States
(12) Patent Application Publication
(10) Pub. No.: US 2008/0229364 A1
(43) Pub. Date: Sep. 18, 2008

(54) System and Method for the Construction of Electronic Program Guide Through Cooperative Transmission of Electronic Program Guide Data

(75) Inventors: Joo Hyeon Ryu, Seoul (KR); Soo Woong Kim, Seoul (KR)

Correspondence Address: HOFFMANN & BARON, LLP, 6900 JERICHO TURNPIKE, SYOSSET, NY, 11791, US

(73) Assignee: ALTICAST CORP., Seoul (KR)

(21) Appl. No.: 11/994,684

(22) PCT Filed: Jul. 3, 2006
(86) PCT No.: PCT/KR2006/002599

§ 371 Date: Jan. 4, 2008

(30) Foreign Application Priority Data
Jul. 5, 2005 (KR) 10-2005-0060089

(51) Int. Cl. H04N 5/445; G06F 3/00

(52) U.S. Cl. 725/54; 725/39

(57) ABSTRACT

The present invention relates to a system and a method for the construction of EPG service through cooperative transmission of electronic program guide data. The system of the present invention comprises an EPG transmission server transmitting, through a forward path mediated by a broadcasting network, a part of total EPG data to be transmitted to a settop box and data into which request commands for remaining EPG data not transmitted via the broadcasting network are embedded; an EPG head end server transmitting the remaining EPG data in response to user's request through a return path mediated by a communication network; and a settop box equipped with an EPG application which processes the EPG data received from the EPG transmission server and the EPG head end server. The EPG data transmitted via the broadcasting network includes both a service description table and an event information table. The system and the method for the construction of EPG service in accordance with the present invention require a significantly reduced broadcasting bandwidth for the EPG data transmission, compared with the conventional method or system. EPG service construction can be achieved using the broadcasting bandwidth of 2 M or smaller. Also, the system is applicable to various EPG applications without sacrificing user's satisfaction at all.

### TECHNICAL FIELD

The present invention relates to a system and a method for the construction of electronic program guide (hereinafter, “EPG”) service. More particularly, the present invention relates to a system and a method for the construction of EPG service through cooperative transmission of EPG data.

### BACKGROUND ART

EPG is referred as program guide information for broadcast programs displayed on the screen of a digital TV or an application for operating the same. As one of essential applications in digital television, the EPG application receives television program guide information from a server, and processes and displays it for the user's convenience. At present, there are 4 to 5 public analog broadcasting channels. But, it is expected that several hundreds of channels will become available through digital broadcasting. Then, it will be difficult to find out which program is serviced on which channel. Thus, the EPG, which guides the scheduled broadcasting programs, will become an essential factor. For more details on EPG, please refer to Korean Patent Nos. 331,834 and 400,010.

EPG data includes a service description table (hereinafter, “SDT”) and an event information table (hereinafter, “EIT”). The SDT provides basic channel information such as channel number, channel name and channel contents, and the EIT provides program information such as program title, program starting time, etc. However, as the number of channels increases, the EIT data of broadcast programs are rapidly increasing, thereby resulting in the increase of the EPG data. At present, 7 days EPG data are provided through the broadcasting bandwidth of about 7 M. This means that the transmission of EPG data through the broadcasting bandwidth will become more and more difficult. This needs to be managed properly without cost increase of the broadcasting service provider.

### DISCLOSURE OF INVENTION

### Technical Problem

An object of the present invention is to provide a system and a method for the efficient construction of EPG service.

Another object of the present invention is to construct EPG service on an interactive digital TV through cooperative transmissions through a forward path using the broadcasting network and through a return path using the communications network.

Still another object of the present invention is to construct EPG service on an interactive digital television through cooperative transmissions through a forward path using the broadcasting network and through a return path using the communications network, through efficient cooperation between an EPG transmission server for the forward path and an EPG head end server for the return path.

### Technical Solution

According to an embodiment of the present invention, there is provided a system for the construction of EPG service comprising: an EPG transmission server transmitting through a forward path mediated by a broadcasting network, a part of EPG data to be transmitted to a settop box and data into which request commands for remaining EPG data not transmitted via the broadcasting network are embedded; an EPG head end server transmitting the remaining EPG data in response to user's request through a return path mediated by a communication network; and a settop box equipped with an EPG application which processes the EPG data received from the EPG transmission server and the EPG head end server.

According to another embodiment of the present invention, there is provided a system for the construction of EPG service, wherein the EPG data transmitted through the forward path mediated by the broadcasting network includes both a service description table and an event information table.

According to further another embodiment of the present invention, there is provided a system for the construction of EPG service comprising: a) an EPG transmission server transmitting a part of EPG data to be transmitted to a settop box and data into which request commands for remaining EPG data not transmitted via the broadcasting network are embedded, comprising: an EPG data manager which manages the EPG data; a controller which checks currently available broadcasting bandwidth and determines which EPG data should be transmitted via the broadcasting network; an EPG request command data embedder which produces the data into which the request commands for remaining EPG data not transmitted through the forward path mediated by the broadcasting are embedded; an encoder which encodes the EPG data and the data into which the request commands for the remaining EPG data are encoded; and a transceiver which receives and transmits the EPG data; b) an EPG head end server transmitting through a return path mediated by a communication network the remaining EPG data not transmitted from the broadcasting network to the settop box in response to user's request, comprising: a transceiver which receives the user's request signal for the remaining EPG data not transmitted through the forward path mediated by the broadcasting network and transmits the requested data to the settop box; an EPG data identifier which identifies the EPG data requested from the user; an EPG data manager which manages the EPG data; an encoder which encodes the EPG data to transmit through the forward path mediated by the communication network; and a controller which controls the transmission of the EPG data through the forward path mediated by the communication network; and c) a settop box equipped with an EPG application which processes the EPG data received from the EPG transmission server and the EPG head end server.

According to still another embodiment of the present invention, there is provided a system for the construction of EPG service, wherein the EPG transmission server which transmits a part of the EPG data through the forward path further comprises an EPG data extractor which extracts the EPG data not transmitted through the forward path mediated by the broadcasting network from the EPG data manager and transmits it to the EPG head end server.

According to still further another embodiment of the present invention, there is provided a system for the construction of EPG service, wherein the EPG head end server further comprises an EPG data converter which converts the EPG data into a format compatible with the EPG application installed into the settop box.

According to still further another embodiment of the present invention, there is provided a system for the construction of EPG service, wherein the determination by the controller of the EPG transmission server on which EPG data should be transmitted via the broadcasting network is performed based on a program broadcasting time.

According to still further another embodiment of the present invention, there is provided a system for the construction of EPG service, wherein the EPG data to be transmitted to the settop box is the EPG data for 7 days, of which the EPG data to be transmitted through the forward path being the EPG data for 1 day and the data in which the request command for the remaining EPG data not transmitted through the forward path mediated by the broadcasting network being the EPG data for the remaining 6 days.

According to still further another embodiment of the present invention, there is provided a method for the construction of EPG service on a settop box equipped with an EPG application, through cooperative transmissions of the EPG data from an EPG transmission server transmitting through a forward path mediated by a broadcasting network, a part of EPG data to be transmitted to a settop box and data into which request commands for remaining EPG data not transmitted via the broadcasting network are embedded, and from an EPG head end server transmitting the remaining EPG data in response to user's request through a return path mediated by a communication network, which comprises the steps of: transmitting, through the forward path mediated by the broadcasting network from an EPG transmission server to the settop box, a part of the EPG data and data into which the request commands for remaining EPG data not transmitted via the broadcasting network are embedded; in response to user's request signal for the remaining EPG data, transmitting, the request signal of the user to the EPG head end server through the return path mediated by a communication network; and receiving the EPG data requested by the user from the EPG head end server through the return path mediated by the communication network and displaying it on a user's television.

### ADVANTAGEOUS EFFECTS

In accordance with the present invention, complete EPG data is provided to an interactive digital TV through cooperative transmissions through the forward path mediated by the broadcasting network and through the return path mediated by the communication network. This reduces significantly the broadcasting bandwidth allocated for the transmission of the EPG data, compared with the conventional method and system for the construction of EPG service. Using about 2 M or smaller bandwidth, the EPG service can be achieved. Analysis on utilization of the EPG data at a side of the user shows that the request for EPG data relevant to the program of today or very near future is prominent. And the program information for the future is sometimes requested based on a particular channel. Accordingly, by cooperative provisions of EPG data relevant to the programs of today or very near including both the service description table and the event information table through a broadcasting network and of the EPG data relevant to the remaining programs in response to the user's request via a communication network, EPG service can be effectively achieved without any scarificing the satisfaction of the user.

Also, the EPG service can be constructed effectively through cooperative interaction of the EPG transmission server that provides, through a forward path mediated by a broadcasting network, a part of EPG data to be transmitted to a settop box and data into which request commands for remaining EPG data not transmitted via the broadcasting network are embedded, and an EPG head end server transmitting the remaining EPG data in response to user's request through a return path mediated by a communication network. Further, the EPG head end server has extendibility applicable to all EPG applications.

### BRIEF DESCRIPTION OF THE DRAWINGS

FIG. 1 is a block diagram illustrating a preferred embodiment of the system for the construction of EPG in accordance with the present invention.

FIG. 2 is a drawing illustrating a preferred embodiment of the EPG displayed on television screen of the user received from the EPG transmission server through forward path in accordance with the present invention.

FIG. 3 is a block diagram illustrating another preferred embodiment of the system for the construction of EPG in accordance with the present invention.

### MODE FOR THE INVENTION

The EPG construction method of the present invention is characterized in that a part of total EPG data is transmitted to the user's settop box through a forward path mediated by a broadcasting network and the remaining EPG data is transmitted to the user's settop box through a return path mediated by a communication network in response to the user's request. Preferably, the EPG data to be transmitted via the broadcasting network and the EPG data to be transmitted via the communications network are determined based on the broadcasting time. For example, in accordance with the conventional method, EPG data for 7 days was transmitted to the user's settop box via the broadcasting network. In this case, it is required for a broadcasting bandwidth of at least 7 M in the transmission of the EPG data for 7 days. However, in accordance with the present invention, EPG data for only 1 day is transmitted via the broadcasting network and the EPG data for the next 6 days is transmitted to the settop box via the communication network upon the receipt of user's request. In this case, the EPG data transmitted via the broadcasting network requires less than 2 M of the broadcasting bandwidth, in which about 1 M for the EPG data for 1 day and less than 1 M for the data into which the request signals for the remaining EPG data for the next 6 days are encoded. Consequently, the broadcasting bandwidth allocated for delivery of the EPG data can be reduced significantly.

The system for the construction of EPG in accordance with the present invention comprises:

a) an EPG transmission server transmitting, through a forward path mediated by a broadcasting network, a part of EPG data to be transmitted to a settop box and data into which request commands for remaining EPG data not transmitted via the broadcasting network are embedded, comprising: an EPG data manager which manages the EPG data; a controller which checks currently available broadcasting bandwidth and determines which EPG data should be transmitted via the broadcasting network; an EPG request command data embedder which produces the data into which the request commands for the remaining EPG data are embedded; an encoder which encodes the EPG data and the data into which the request commands are encoded; and a transceiver which receives and transmits the EPG data;

b) an EPG head end server transmitting, through a return path mediated by a communication network, the remaining EPG data not transmitted from the broadcasting network to the settop box in response to user's request, comprising: a transceiver which receives the user's request signal for the remaining EPG data not transmitted via the broadcasting network and transmits the requested EPG data to the settop box; an EPG data identifier which identifies the EPG data requested from the user; an EPG data manager which manages the EPG data; an encoder which encodes the EPG data to transmit through the forward path mediated by the communication network; and a controller which controls the transmission of the EPG data through the forward path mediated by the communication network; and

c) a settop box equipped with an EPG application which processes the EPG data received from the EPG transmission server and the EPG head end server.

The EPG data transmitted through the forward path includes both the service description table (“SDT”) and the event information table (“EIT”). That is, all the information including the basic channel information such as channel number, channel name and channel contents and the program information such as program title, program starting time, etc. are provided. This EPG data is the program guide information relevant to the programs of today or near future. For example, all the EPG data for the programs of today is provided to all the settop boxes of the users connected to the broadcasting network through the forward path. When a user selects the EPG data transmitted through the forward path, the data can be processed in real time because it is stored in the user's cache memory.

The remaining EPG data not transmitted through the forward path is transmitted from the EPG transmission server to all the settop boxes in a form of the data into which the request commands for the EPG data are embedded with aid of the EPG request signal data embedder. This data is the information for the future. For example, it is the EPG data for the next 6 days. When the data is requested at the user end, the user's request is transmitted to the EPG head end server through the return path. That is, a new process begins to request the information in response to the user's request.

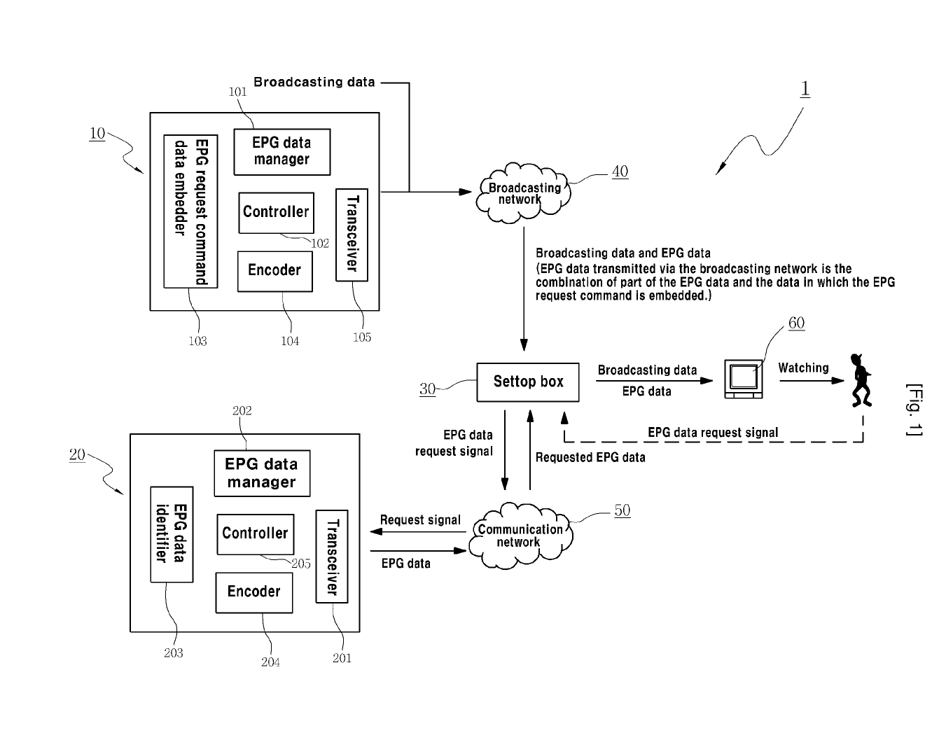

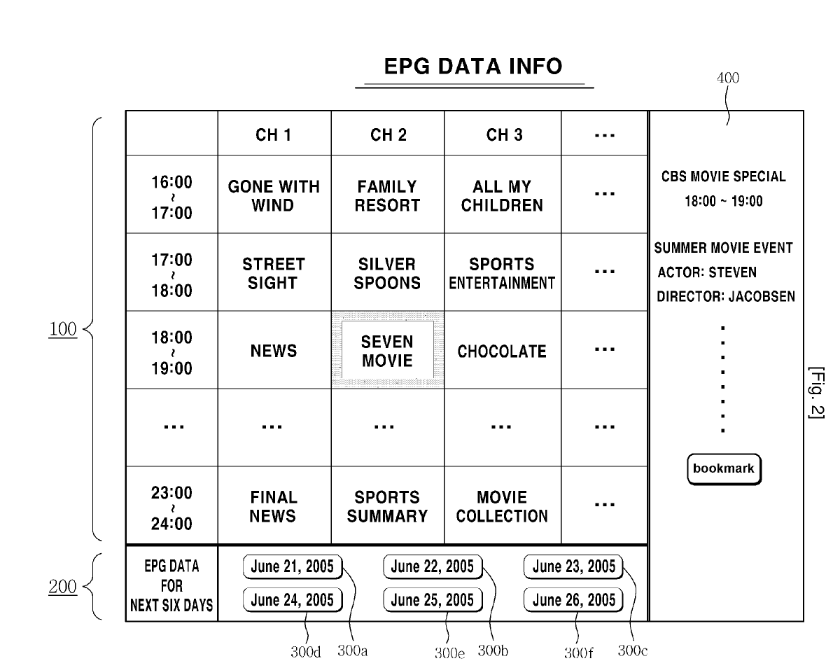

FIG. 1 is a block diagram illustrating a preferred embodiment of the system for the construction of EPG in accordance with the present invention, and FIG. 2 is a drawing illustrating a preferred embodiment of the EPG displayed on television screen of the user received from the EPG transmission server through a forward path in accordance with the present invention. The present invention will be more fully illustrated referring to FIG. 1 and FIG. 2.

As illustrated in FIG. 1, the system for the construction of EPG of the present invention (1) comprises an EPG transmission server (10) and an EPG head end server (20). The EPG transmission server (10) comprises an EPG data manager (101) which manages the EPG data, a controller (102) which checks currently available broadcasting bandwidth and determines which EPG data is to be transmitted via the broadcasting network, an EPG request command data embedder (103) which produces a data into which the request commands for the remaining EPG data not transmitted via the broadcasting network is embedded, an encoder (104) which encodes the EPG data and the data into which the request commands for the remaining EPG data not transmitted via the broadcasting network and a transceiver (105) which transmits and receives the EPG data. The encoded EPG data is transmitted to the user's settop box (30) through the forward path mediated by the broadcasting network (40) in combination with other broadcasting signals.

As illustrated in FIG. 2, the EPG data (100) for the programs of today includes both the service description table (SDT) and the event information table (EIT). However, the EPG data for the remaining 6 days (200) are expressed as icons (300a to 300f, totally 300) into which the request commands for the remaining EPG data is embedded. The user may acquire the EPG data of today (100) for a specific channel from the displayed EPG screen. More detailed additive information can be also acquired by selecting the title of the EPG data (100). Specifically, when the title of the EPG data (100) is selected, the information stored in the cache memory of the settop box (30) is displayed on a detailed information display window (400), which can be checked in real time.

To obtain the remaining EPG data (200) of the next days for a specific channel, the user selects one of the icons (300). Then, the user's request is delivered to the from the EPG head end server (20), and then the corresponding EPG data is delivered from the EPG head end server (20) through the return path and is displayed. In FIG. 2, the EPG data (200) are classified based on the date. However, they may also be classified based on channel. In this case, the EPG data for the specific date and specific channel may be displayed on the screen when the user selects an icon (300).

The EPG head end server (20) transmits the remaining EPG data not transmitted through the forward path in response to the user's request. For this purpose, the EPG head end server (20) comprises a transceiver (201) which receives the request signal for the remaining EPG data not transmitted via the broadcasting network from the user and transmits the data to the settop box of the user, an EPG data identifier (202) which identifies the EPG data requested from the user, an EPG data manager (203) which manages the EPG data, an encoder (204) which encodes the EPG data, and a controller (205) which controls the transmission of the EPG data via the communication network.

First, when the user selects one of the icons (300) into which the request command for the remaining EPG data (200) not transmitted via the broadcasting network (40) is embedded, the settop box (30) transmits the request signal for the EPG data (200) embedded in the icon (300) to the EPG head end server (20). The request signal is received by the transceiver (201) of the EPG head end server (20). The EPG data identifier (202) analyzes the request signal and identifies the requested EPG data.

Then, the corresponding EPG data is extracted from the EPG data manager (203) which manages the EPG data not transmitted via the broadcasting network (40), under the control of the controller (204), adequately encoded by the encoder (204) and transmitted to the settop box (30) through the return path using the communication network (50). Subsequently, it is displayed on the user's TV screen (60) by the action of EPG application installed into the settop box (30).

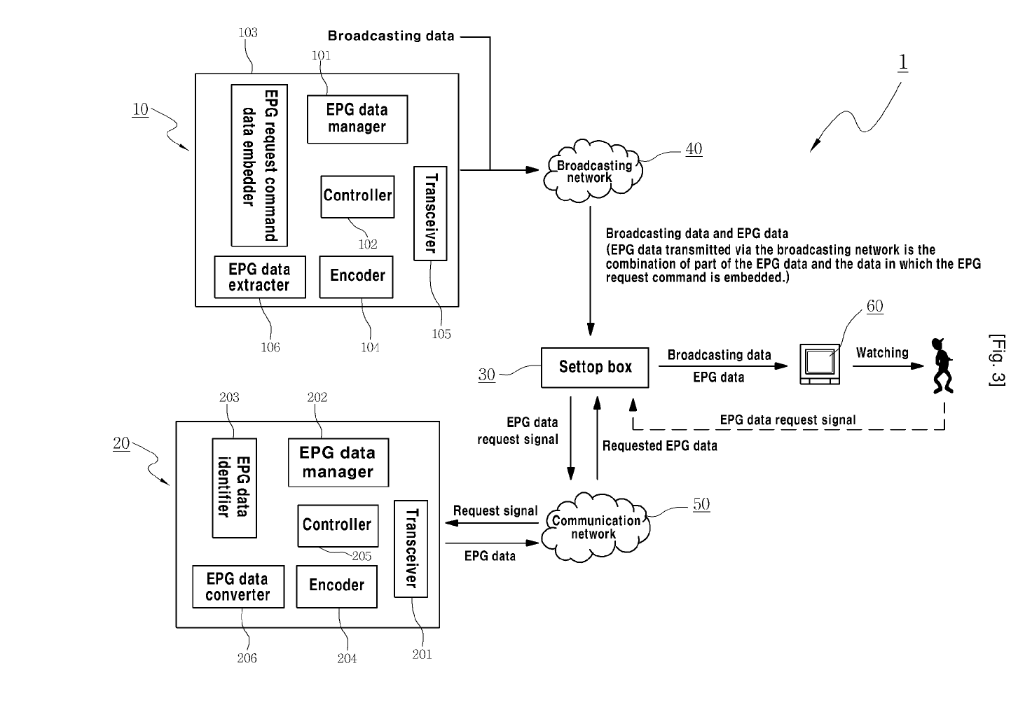

FIG. 3 is a block diagram illustrating another preferred embodiment of the system for the construction of EPG in accordance with the present invention. In the system for the construction of EPG (1) illustrated in FIG. 3, the EPG transmission server (10) further comprises an EPG data extractor (106) which extracts the remaining EPG data not transmitted via the broadcasting network (40) and transmits it to the EPG head end server (20) through the transceiver (105). The EPG data extracted by the EPG data extractor (106) is transmitted to the EPG head end server (20) and managed by the EPG data manager (203). Since the remaining EPG data not transmitted via the broadcasting network (40) is transmitted to the EPG head end server (20), the EPG head end server (20) needs not manage the EPG data (100) transmitted to the settop box (30) through the forward path. This improves the EPG data management efficiency of the EPG head end server (20). In other words, the EPG head end server (20) has only to manage the EPG data extracted by the EPG data extractor (106) of the EPG transmission server (10). Consequently, a perfect cooperation between the EPG transmission server (10) and the EPG head end server (20) is attained.

And, the EPG head end server (20) further comprises an EPG data converter (206) which converts the EPG data into a format compatible with the EPG application installed into the user's settop box (30). The EPG data converter (206) makes the EPG data provided by the EPG head end server (20) applicable to various EPG applications.

A single EPG transmission server (10) is illustrated in FIG. 1, but a plurality of EPG transmission servers may used to provide a plurality of incompatible EPG data via the broadcasting network (40). In this case, the users may request incompatible EPG data to the EPG head end server (20), which may be a barrier to the perfect construction of EPG. However, in accordance with the present invention, the EPG head end server (20) provides the EPG data which is completely compatible with the EPG application installed into each of the settop boxes (30), which are incompatible with one another other. In this case, the user's request signal for the EPG data will include an EPG data identification information and the EPG application identification information of the settop box.

The present invention also relates to a method for the construction of EPG service.

Particularly, the present invention relates a method for the construction of EPG service on a settop box equipped with an EPG application, through cooperative transmissions of the EPG data from an EPG transmission server transmitting through a forward path mediated by a broadcasting network, a part of EPG data to be transmitted to a settop box and data into which request commands for remaining EPG data not transmitted via the broadcasting network are embedded, and from an EPG head end server transmitting the remaining EPG data in response to user's request through a return path mediated by a communication network, which comprises the steps of: transmitting, through the forward path mediated by the broadcasting network from an EPG transmission server to the settop box, a part of the EPG data and data into which the request commands for remaining EPG data not transmitted via the broadcasting network are embedded; in response to user's request signal for the remaining EPG data, transmitting, the request signal of the user to the EPG head end server through the return path mediated by the communication network; and receiving the EPG data requested by the user from the EPG head end server through the return path mediated by the communication network and displaying it on a user's television.

As described, it should be evident that the present invention can be implemented through a variety of configurations in the aforementioned technical field without affecting, influencing or changing the spirit and scope of the invention. Therefore, it is to be understood that the examples and applications illustrated herein are intended to be in the nature of description rather than of limitation. Furthermore, the meaning, scope and higher conceptual understandings of the present patent application as well as modifications and variations that arise therefrom should be understood to be extensions to this application.

1. A system for the construction of EPG (electronic program guide) service, comprising: an EPG transmission server transmitting, through a forward path mediated by a broadcasting network, a part of total EPG data to be transmitted to a settop box and data into which request commands for remaining EPG data not transmitted via the broadcasting network are embedded; an EPG head end server transmitting the remaining EPG data in response to user's request through a return path mediated by a communication network; and a settop box equipped with an EPG application which processes the EPG data received from the EPG transmission server and the EPG head end server.

2. The system as set forth in claim 1, wherein the EPG data transmitted via the broadcasting network includes both a service description table and an event information table.

3. The system as set forth in claim 1, wherein:
a) the EPG transmission server comprises: an EPG data manager which manages the EPG data; a controller which checks currently available broadcasting bandwidth and determines which EPG data can be transmitted via the broadcasting network; an EPG request command data embedder which produces the data into which request commands for the remaining EPG data not transmitted via the broadcasting network are embedded; an encoder which encodes the partial EPG data transmitted via the broadcasting network and the data into which the request commands for the remaining EPG data to transmit them via the broadcasting network; and a transceiver which receives and transmits the EPG data;
b) the EPG head end server comprises: a transceiver which receives the user's request signal for the remaining EPG data not transmitted through the forward path mediated by the broadcasting network and transmits the requested data to the settop box; an EPG data identifier which identifies the EPG data requested from the user; an EPG data manager which manages the EPG data; an encoder which encodes the EPG data to transmit the EPG data through the forward path mediated by the communication network; and a controller which controls the transmission of the EPG data through the forward path mediated by the communication network; and
c) a settop box is equipped with an EPG application which processes the EPG data received from the EPG transmission server and the EPG head end server.

4. The system as set forth in claim 3, wherein the EPG transmission server further comprises an EPG data extractor which extracts the EPG data not transmitted via the broadcasting network from the EPG data manager and transmits it to the EPG head end server.

5. The system as set forth in claim 3, wherein the EPG head end server further comprises an EPG data converter which converts the EPG data into a format compatible with the EPG application installed into the settop box.

6. The system as set forth in claim 3, wherein the determination by the controller of the EPG transmission server on which EPG data should be transmitted via the broadcasting network is performed based on a program broadcasting time.

7. The system as set forth in claim 6, wherein the total EPG data to be transmitted to the settop box is the EPG data for 7 days, of which the EPG data to be transmitted through the forward path being the EPG data for 1 day and the data into which the request commands for the remaining EPG data being the EPG data for the remaining 6 days.

8. A method for the construction of EPG (electronic program guide) service on a settop box equipped with an EPG application through cooperative transmissions of the EPG data from an EPG transmission server transmitting through a forward path mediated by a broadcasting network, a part of EPG data to be transmitted to the settop box and data into which request commands for remaining EPG data not transmitted via the broadcasting network are embedded, and from an EPG head end server transmitting the remaining EPG data in response to user's request through a return path mediated by a communication network, which comprises the steps of: transmitting, through the forward path mediated by the broadcasting network from the EPG transmission server to the settop box, the partial EPG data and the data into which the request commands for remaining EPG data; in response to user's request signal for the remaining EPG data, transmitting, the request signal of the user to the EPG head end server through the return path mediated by the communication network; and receiving the EPG data requested by the user from the EPG head end server through the return path mediated by the communication network and displaying it on a user's television.

9. The method as set forth in claim 8, wherein the EPG data transmitted via the broadcasting network includes both a service description table and an event information table.

10. The method as set forth in claim 8, wherein the user's request signal for the remaining EPG data includes an EPG identification information and an EPG application identification information, and the EPG head end server identifies the EPG application installed into the settop box from the EPG application identification information and converts the requested EPG data to a format compatible with the EPG application and transmits it to the settop box through the return path.
